(19) United States
(12) Patent Application Publication
(10) Pub. No.: US 2003/0087994 A1
(43) Pub. Date: May 8, 2003

(54) Flax-filled composite

(75) Inventor: John P. Frechette, Powell, OH (US)

Correspondence Address: STANDLEY & GILCREST LLP, 495 METRO PLACE SOUTH, SUITE 210, DUBLIN, OH, 43017, US

(73) Assignee: Crane Plastics Company Limited Partnership, Columbus, OH (US)

(21) Appl. No.: 10/045,519

(22) Filed: Oct. 26, 2001

(51) Int. Cl. C08J 3/00; C08L 89/00; C08K 11/00

(52) U.S. Cl. 524/9

(57) ABSTRACT

Foamed and solid, flax-filled composites. The flax filler may be used as a substitute for wood fiber, wood flour, and other cellulosic fillers in synthetic wood composites. The flax filler may be present in an amount up to about 55% by weight of an exemplary solid composite. In an exemplary foamed composite, the flax filler may be present in an amount up to about 40% by weight.

### BACKGROUND AND SUMMARY OF THE INVENTION

The present invention relates generally to wood replacement materials, and more particularly, to synthetic wood composite materials. The present invention will be described primarily with reference to foamed and unfoamed, flax-filled, polyvinyl chloride (PVC) composites. However, the present invention includes several different formulations and material composites including, but not limited to, high density polyethylene (HDPE) formulations and polypropylene formulations that include a flax filler.

The supply of natural woods for construction and other purposes is dwindling. When a tree is harvested for manufacturing purposes, it takes many years to grow another tree of similar size in its place. As a result, many are concerned about conserving the world's forests, and the cost of natural woods has risen. In light of these factors, a tremendous demand has developed in recent years for synthetic wood composites that exhibit the look and feel of natural woods.

Wood fiber/polymer composites and wood flour/polymer composites have been used as replacements for all-natural wood, particle board, wafer board, and other similar materials. For example, U.S. Pat. Nos. 3,908,902, 4,091,153, 4,686,251, 4,708,623, 5,002,713, 5,055,247, 5,087,400, and 5,151,238 relate to processes for making wood replacement products. As compared to natural woods, wood fiber/polymer composites and wood flour/polymer composites may offer superior resistance to wear and tear. In addition, wood fiber/polymer composites and wood flour/polymer composites may have enhanced resistance to moisture. In fact, it is well known that the retention of moisture is a primary cause of the warping, splintering, and discoloration of natural woods. Moreover, wood fiber/polymer composites and wood flour/polymer composites may be sawed, sanded, shaped, turned, fastened, and finished in the same manner as natural woods. Consequently, wood fiber/polymer composites and wood flour/polymer composites have been used for applications such as interior and exterior decorative house moldings, picture frames, furniture, porch decks, deck railings, window moldings, window components, door components, roofing structures, building siding, and other suitable indoor and outdoor items.

Despite the benefits of wood fiber/polymer composites and wood flour/polymer composites versus natural wood, the use of wood fiber or wood flour in synthetic wood composites also has drawbacks. These wood composites may be filled with wood fiber or wood filler in an amount up to about 70% by weight. As a result, the use of wood fiber or wood filler in synthetic wood composites still depletes the supply of natural wood.

The present invention provides flax-filled composite materials that can be produced in a commercially reasonable environment. Flax offers advantages over wood fiber and wood flour as a filler for synthetic wood composites. In contrast to wood flour and wood fiber, flax is a crop that is renewable on a yearly basis. Consequently, the use of flax as a filler is more environmentally friendly. The inventor has also surprisingly discovered that flax flour typically dries more quickly than wood flour and wood fiber at equivalent temperatures. As a result, the use of flax as a filler may lead to lower energy costs due to shortened drying time as compared to manufacturing processes that include a step of drying wood flour or wood fiber.

The flax-filled composites of the present invention can be processed and shaped into resultant products having desired appearance, strength, durability, and weatherability. The flax-filled composites may be used to make components previously made with natural wood, wood fiber/polymer composites, wood flour/polymer composites, other various types of cellulosic-filled composites, and/or inorganic-filled composites. For instance, the flax-filled composites of the present invention may be used to make interior and exterior decorative house moldings, picture frames, furniture, porch decks, deck railings, floor components, window moldings, window components, door components, roofing structures, building siding, and other suitable indoor and outdoor items.

In addition to the novel features and advantages mentioned above, other objects and advantages of the present invention will be readily apparent from the following descriptions of the drawings and exemplary embodiments.

### BRIEF DESCRIPTION OF THE DRAWINGS

FIG. 1 is a schematic view of one embodiment of an extrusion system that may be used to process a flax-filled composite of the present invention.

### DETAILED DESCRIPTION OF EXEMPLARY EMBODIMENT(S)

The present invention is directed to flax-filled composite materials. The flax filler may be used a total substitute for wood fiber, wood flour, other cellulosic fillers, and/or inorganic fillers in some synthetic wood composites of the present invention. However, in other embodiments, the composites may include flax filler in addition to wood fiber, wood flour, other cellulosic fillers, and/or inorganic fillers. Various examples of flax-filled composites are provided herein. Most preferably, a composite of the present invention includes flax filler and a polymer selected from the group consisting of PVC, HDPE, and polypropylene. Nevertheless, it should be recognized that the present invention also includes any polymer composite that includes flax filler in any amount, regardless of the type of polymer in the composite.

The flax filler may be used to enhance the structural characteristics of foamed and unfoamed synthetic wood composites. An exemplary embodiment of an unfoamed (i.e., solid), flax-filled composite may include flax in an amount up to about 55% by weight of the composite. On the other hand, an exemplary embodiment of a foam composite may include flax in an amount up to about 40% by weight of the composite, more preferably between about 20% and about 40% by weight of the composite. However, it should be recognized that other solid composites of the present invention may include a flax filler in an amount greater than 55% by weight of the composition. Likewise, other foam composites of the present invention may include a flax filler in an amount greater than about 40% by weight of the composition. The flax filler preferably has a size of between about 35 and about 60 mesh. Again, however, it should be recognized that the flax filler may be larger than 35 mesh or smaller than 60 mesh in other embodiments of the present invention.

In addition to the flax, a composite of the present invention may include other ingredients including, but not limited to, cellulosic fillers, polymers, plastics, thermoplastics, rubber, inorganic fillers, cross-linking agents, lubricants, process aids, stabilizers, accelerators, inhibitors, enhancers, compatibilizers, chemical blowing/foaming agents, foam modifiers, weathering additives, and other similar, suitable, or conventional materials materials. Examples of cellulosic fillers include sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, bagass, plant fibers, bamboo fiber, palm fiber, kenaf, and other similar, suitable, or conventional materials. Examples of polymers include multilayer films, HDPE, polypropylene, PVC, low density polyethylene (LDPE), chlorinated polyvinyl chloride (CPVC), acrylonitrile butadiene styrene (ABS), ethyl-vinyl acetate, polystyrene, other similar copolymers, other similar, suitable, or conventional plastic materials, and formulations that incorporate any of the aforementioned polymers. Examples of inorganic fillers include talc, calcium carbonate, kaolin clay, magnesium oxide, titanium dioxide, silica, mica, barium sulfate, acrylics, and other similar, suitable, or conventional materials. Titanium dioxide is also an example of a weathering additive. Other similar, suitable, or conventional weathering additives may be used in the present invention including, but not limited to, other ultraviolet absorbers. Examples of other ultraviolet absorbers include organic chemical agents such as benzophenone and benzotriazole types. Examples of lubricants include zinc stearate, calcium stearate, esters, amide wax, paraffin wax, ethylene bis-stearamide, and other similar, suitable, or conventional materials. Examples of stabilizers include tin stabilizers, lead and metal soaps such as barium, cadmium, and zinc, and other similar, suitable, or conventional materials. Examples of process aids include acrylic process aids and other similar, suitable, or conventional materials. R & H K-120N and R & H K-175 are examples of acrylic process aids that are available from Rohm & Haas. Examples of foam modifiers include acrylic foam modifiers and other similar, suitable, or conventional foam modifiers. An example of an acrylic foam modifier is R & H K-400, which is available from Rohm & Haas. The blowing agent may be an endothermic or exothermic blowing agent. An example of a chemical endothermic blowing agent is Hydrocerol BIH (i.e., sodium bicarbonate/citric acid), available from Clariant Corp., whereas an example of a chemical exothermic foaming agent is azodicarbonamide, available from Uniroyal Chemical Co.

One embodiment of a solid, flax-filled, PVC composite may be comprised of flax filler, PVC resin, at least one stabilizer, at least one lubricant, and at least one process aid. Optionally, this embodiment of the present invention may also include at least one inorganic filler. The ingredients of this example may be included in the following approximate amounts:

| | PARTS BY WEIGHT | PARTS BY WEIGHT |
|---|---|---|
| INGREDIENT | (PREFERRED) | (MORE PREFERRED) |
| Flax | 20-140 | 110-130 |
| PVC | 100 | 100 |
| Stabilizer(s) | 1-8 | 2-6 |
| Lubricant(s) | 1-15 | 2-8 |
| Process Aid(s) | 1-12 | 1-5 |
| Inorganic Filler(s) | 0-20 | 0-10 |

This embodiment of the flax-filled composite may typically have a density of about 1.25 to about 1.35 g/cc. Nevertheless, certain alternatives of this embodiment may have a density of less than 1.25 g/cc or more than 1.35 g/cc.

On the other hand, an embodiment of a foamable, flax-filled PVC composite may be comprised of flax filler, PVC resin, at least one stabilizer, at least one inorganic filler, at least one lubricant, at least one process aid, and at least one blowing agent. The ingredients of this example may be included in the following approximate amounts:

| | PARTS BY WEIGHT | PARTS BY WEIGHT |
|---|---|---|
| INGREDIENT | (PREFERRED) | (MORE PREFERRED) |
| Flax | 20-140 | 47-70 |
| PVC | 100 | 100 |
| Stabilizer(s) | 1-6 | 2-4 |
| Lubricant(s) | 1-12 | 2-6 |
| Process Aid(s) | 0-12 | 1-3 |
| Foam Modifier(s) | 1-20 | 1-12 |
| Weathering | 0-15 | less than 12 |
| Additive(s) | | |
| Inorganic Filler(s) | 0-25 | 5-15 |
| Blowing Agent | less than 2 | less than 1 |

The density of this embodiment of the flax-filled composite may typically be between about 0.4 and about 0.9 g/cc. However, some variations of this embodiment may have a density of less than 0.4 g/cc or greater than 0.9 g/cc.

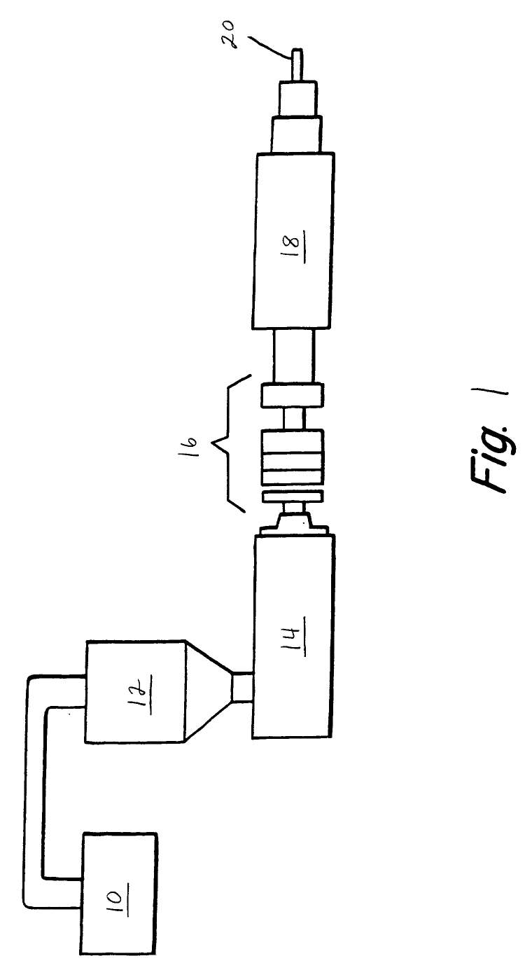

A composite of the present invention may mixed together and processed by extrusion, compression molding, injection molding, or any other similar, suitable, or conventional processing techniques for synthetic wood composites. FIG. 1 shows one example of an extrusion system that may be used to process a composite of the present invention. The ingredients of the polymer material, e.g., a PVC compound, may be mixed together in a high intensity mixer, such as those made by Henschel Mixers America, Inc. The flax may be dried to a desired moisture level, e.g., about 2% by weight or below. The polymer material and flax may be then mixed together in a mixer 10. For example, a low intensity mixer may be used. An example of a low intensity mixer is a ribbon blender. After being mixed together, the ingredients may be transferred to a feed hopper 12. Alternatively, some or all of the ingredients may be separately input to the feed hopper 12 using automated loss-in-weight feeders. An example of a feed hopper 12 is a gravity feed hopper or a hopper with a force feed mechanism known as a crammer. The feed hopper 12 transfers the composite to a heated extruder 14. The extruder 14 blends the ingredients under sufficient heat and pressure. Several well-known extruders may be used in the present invention, e.g., a twin screw extruder by Cincinnati Milacron (CM-80-Hp). The extruder 14 forces the composite through a die system 16. In an exemplary embodiment, the flow rate of the extruder 14 may be between about 150 and 600 pounds per hour. In other embodiments, the flow rate may be higher or lower depending on the type and size of the extruder 14. The die system 16 may be made up of one or more plates. The die system 16 allows the starting materials to bond and form a shaped-homogeneous product. A typical plate may be made from hardened steel material, stainless steel material or other types of metals. A cooling system (e.g., a liquid bath or spray, an air cooling system, or a cryogenic cooling system) may follow the die system 16.

### EXAMPLES

One example of a solid, flax-filled, PVC composite is comprised of the following ingredients:

| INGREDIENT | PARTS BY WEIGHT |
|---|---|
| Flax | 120 |
| PVC | 100 |
| Stabilizer(s) | 4 |
| Lubricant(s) | 6 |
| Inorganic Filler(s) | 7.5 |
| Process Aid(s) | 3 |

The composite ingredients were blended together in a twin screw extruder made by Brabender to form a composite melt. The crammer feeder was set at 30. The temperatures of the various zones of the extruder were 370° F., 370° F., and 355° F., respectively. The screw torque of the extruder was 6500 meter-grams, and the head pressure was 5500 psi. In addition, the extruder exerted a 20-inch vacuum. The density of the composite ranged from 1.25 to 1.30 g/cc, and the composite was processed through the extruder at a rate ranging from 120 to 140 grams/minute. The extruder forced the composite melt through a die to form a structural component. The die temperature was 355° F. The structural component exhibited desired appearance, strength, durability, and weatherability.

In another example, a flax-filled, foam composite was extruded to form a decorative component. The composite was comprised of the following ingredients:

| INGREDIENT | PARTS BY WEIGHT |
|---|---|
| Flax | 57 |
| PVC | 100 |
| Stabilizer(s) | 3 |
| Lubricant(s) | 4 |
| Process Aid(s) | 1 |
| Foam Modifier(s) | 12 |
| Inorganic Filler(s) | 10 |
| Blowing Agent | 0.7 |

The composite ingredients were blended together in a twin screw extruder made by Brabender to form a composite melt. The crammer feeder was set at 30. The temperatures of the various zones of the extruder were 355° F., 360° F., and 355° F., respectively. The screw torque of the extruder ranged from 3700 to 4900 meter-grams, and the head pressure ranged from 1200 to 1500 psi. The density of the composite ranged from 0.6 to 0.8 g/cc, and the composite was processed through the extruder at a rate ranging from 75 to 95 grams/minute. The extruder forced the composite melt through a die to form a structural component. The die temperature was 355° F. The structural component exhibited desired appearance, strength, durability, and weatherability.

Another example of a highly weatherable PVC foam composite is comprised of the following ingredients:

| INGREDIENT | PARTS BY WEIGHT |
|---|---|
| Flax | 60 |
| PVC | 100 |
| Stabilizer(s) | 2.5 |
| Lubricant(s) | 4 |
| Process Aid(s) | 1 |
| Weathering Additive(s) | 10 |
| Inorganic Filler(s) | 11 |
| Foam Modifier(s) | 10 |
| Blowing Agent | 0.85 |

The composite ingredients were blended together in a twin screw extruder made by Brabender to form a composite melt. The crammer feeder was set at 30. The temperatures of the various zones of the extruder were 355° F., 360° F., and 355° F., respectively. The screw torque of the extruder ranged from 5000 to 5300 meter-grams, and the head pressure ranged from 1400 to 1500 psi. The density of the composite ranged from 0.6 to 0.8 g/cc, and the composite was processed through the extruder at a rate ranging from 75 to 95 grams/minute. The extruder forced the composite melt through a die to form a structural component. The die temperature was 355° F. The structural component exhibited desired appearance, strength, durability, and weatherability.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described preferred embodiments of the present invention, those skilled in the art will realize that many variations and modifications may be made to affect the described invention. Many of those variations and modifications will provide the same result and fall within the spirit of the invention. It is the intention, therefore, to limit the invention only as indicated by the scope of the claims.

What is claimed is:

1. A composite comprising:
flax; and
at least one polymer.

2. The composite of claim 1 wherein said at least one polymer is selected from the group consisting of polyvinyl chloride, high density polyethylene, and polypropylene.

3. The composite of claim 1 further comprising at least one stabilizer.

4. The composite of claim 1 further comprising at least one lubricant.

5. The composite of claim 1 further comprising at least one process aid.

6. The composite of claim 1 further comprising:
at least one foam modifier; and
at least one blowing agent.

7. The composite of claim 1 further comprising:
at least one stabilizer;
at least one lubricant; and
at least one process aid.

8. The composite of claim 1 further comprising:
at least one stabilizer;
at least one lubricant;
at least one process aid;
at least one foam modifier; and
at least one blowing agent.

9. A composite comprising:
flax in an amount of about 20-140 parts by weight;
a polymer resin in an amount of about 100 parts by weight;
at least one stabilizer in a total amount of about 1-8 parts by weight;
at least one lubricant in a total amount of about 1-15 parts by weight; and
at least one process aid in a total amount of about 1-12 parts by weight.

10. The composite of claim 9 wherein said polymer resin is selected from the group consisting of polyvinyl chloride resin, high density polyethylene resin, and polypropylene resin.

11. The composite of claim 10 wherein said polymer resin is said polyvinyl chloride resin.

12. The composite of claim 10 wherein said polymer resin is said high density polyethylene resin.

13. The composite of claim 9 further comprising at least one inorganic filler in an amount less than about 20 parts by weight.

14. The composite of claim 9 wherein:
said flax is in an amount of about 110-130 parts by weight;
said polymer resin is in an amount of about 100 parts by weight;
said at least one stabilizer is in a total amount of about 2-6 parts by weight;
said at least one lubricant is in a total amount of about 2-8 parts by weight; and
said at least one process aid is in a total amount of about 1-5 parts by weight.

15. The composite of claim 14 further comprising at least one inorganic filler in an amount less than about 10 parts by weight.

16. A composite comprising:
flax in an amount of about 20-140 parts by weight;
a polymer resin in an amount of about 100 parts by weight;
at least one stabilizer in a total amount of about 1-6 parts by weight;
at least one lubricant in a total amount of about 1-12 parts by weight;
at least one foam modifier in a total amount of about 1-20 parts by weight;
at least one process aid in a total amount of about 1-12 parts by weight; and
a blowing agent in a total amount of less than about 2 parts by weight.

17. The composite of claim 16 wherein said polymer resin is selected from the group consisting of polyvinyl chloride resin, high density polyethylene resin, and polypropylene resin.

18. The composite of claim 16 wherein:
said flax is in an amount of about 47-70 parts by weight;
said polymer resin is in an amount of about 100 parts by weight;
said at least one stabilizer is in a total amount of about 2-4 parts by weight;
said at least one lubricant is in a total amount of about 2-6 parts by weight;
said at least one foam modifier is in a total amount of about 1-12 parts by weight;
said at least one process aid is in a total amount of about 1-3 parts by weight; and
said blowing agent is in a total amount of less than about 1 part by weight.

19. The composite of claim 18 further comprising at least one inorganic filler in a total amount of about 5-15 parts by weight.

20. The composite of claim 18 further comprising at least one weathering additive in a total amount of less than about 12 parts by weight.
